(19) United States
(12) Patent Application Publication
(10) Pub. No.: US 2022/0206767 A1
(43) Pub. Date: Jun. 30, 2022

(54) METHOD FOR COMPILING SOURCE CODE OF EMBEDDED PROCESSOR AND COMPILER THEREOF

(71) Applicant: Electronics and Telecommunications Research Institute, Daejeon (KR)

(72) Inventors: Jinyong LEE, Daejeon (KR); Donghyeun KWON, Daejeon (KR)

(73) Assignee: Electronics and Telecommunications Research Institute, Daejeon (KR)

(21) Appl. No.: 17/565,148

(22) Filed: Dec. 29, 2021

(30) Foreign Application Priority Data
Dec. 30, 2020 (KR) 10-2020-0188049

(51) Int. Cl. G06F 8/41; G06F 21/57

(52) U.S. Cl. CPC G06F 8/44; G06F 2221/033; G06F 21/577

(57) ABSTRACT

A method and a compiler for compiling of a source code of a program of an embedded processor including: determining a target memory statement to access a memory region of the embedded processor from among memory statements included in the source code; inserting, in the vicinity of the target memory statement, an additional statement to detect a memory vulnerability error when the target memory statement accesses the memory region; changing the target memory statement into binary codes; and changing the additional statement into binary codes are provided.

### CROSS-REFERENCE TO RELATED APPLICATION

This application claims priority to and the benefit of Korean Patent Application No. 10-2020-0188049 filed in the Korean Intellectual Property Office on Dec. 30, 2020, the entire contents of which are incorporated herein by reference.

### BACKGROUND OF THE INVENTION

### (a) Field of the Invention

This description relates to a method and a compiler for compiling source codes of an embedded processor.

### (b) Description of the Related Art

Memory vulnerabilities refer to vulnerabilities such as Stack Overflow, Heap Overflow, and User After Free. The memory vulnerability allows aggressors to access and forge the memory that stores important information of the attack-target system. Therefore, to configure a safe computing system, software that can safely and efficiently detect the memory vulnerabilities is required.

Address sanitizer is a representative memory vulnerability detection software. The address sanitizer can detect the memory vulnerabilities by determining whether an operation that uses memories is being exploited for the memory vulnerabilities.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An embodiment provides a method for compiling of a source code of a program of an embedded processor.

Another embodiment provides a compiler for compiling of a source code of a program of an embedded processor.

According to an embodiment, a method for compiling of a source code of a program of an embedded processor is provided. The method includes determining a target memory statement to access a memory region of the embedded processor from among memory statements included in the source code; inserting, in the vicinity of the target memory statement, an additional statement to detect a memory vulnerability error when the target memory statement accesses the memory region; changing the target memory statement into binary codes; and changing the additional statement into binary codes.

The additional statement may include a first additional statement that allocates dummy data to a neighboring stack of a stack to which data of the target memory statement is allocated.

The additional statement may further include a second additional statement for writing a bit in a shadow memory corresponding to the dummy data.

The additional statement may further include a third additional statement for displaying a notification to a user of the embedded processor when the bit written by the second additional statement in the shadow memory corresponding to the dummy data is a predetermined value.

The notification may include an audiovisual warning indicating that a memory vulnerability error has occurred for the memory region.

The method may further include generating a program to which the address sanitizer function is applied based on the binary codes of the target memory statement and the binary codes of the additional statement.

According to another embodiment, a compiler for compiling of a source code of a program of an embedded processor is provided. The compiler includes a processor and memory, wherein the processor executes a program stored in the memory to execute: determining a target memory statement to access a memory region from among memory statements included in the source code; Inserting, around the target memory statement, an additional statement to detect a memory vulnerability when the target memory statement accesses the memory region; changing the target memory statement into binary codes; and changing the additional statement into binary codes.

The additional statement may include a first additional statement that allocates dummy data to a neighboring stack of a stack to which data of the target memory statement is allocated.

The additional statement may further include a second additional statement that check a bit in a shadow memory corresponding to the dummy data.

The additional statement may further include a third additional statement for displaying a notification to a user of the embedded processor when the bit written by the second additional statement in the shadow memory corresponding to the dummy data is a predetermined value.

The notification may include an audiovisual warning indicating that a memory vulnerability error has occurred for the memory region.

The processor may execute the program to further perform generating a program to which the address sanitizer function is applied based on the binary codes of the target memory statement and the binary codes of the additional statement.

### BRIEF DESCRIPTION OF THE DRAWINGS

FIG. 1 is a flowchart illustrating a method for compiling source codes of a program of an embedded processor by a compiler according to an embodiment.

FIG. 2 is a schematic view illustrating an address space of a memory for an embedded processor according to an embodiment.

FIG. 3 is a schematic view illustrating a shadow memory allocated in the memory according to an embodiment.

FIG. 4 is a schematic view illustrating a structure of a shadow memory region according to an embodiment.

FIG. 5 is a schematic view illustrating stacks and the shadow memory of a main memory region according to an embodiment.

FIG. 6 is a diagram illustrating source codes before insertion of additional statements and source codes after the insertion according to an embodiment.

FIG. 7 is a schematic view illustrating the stacks of the main memory region changed by the additional statements according to an embodiment.

FIG. 8 is a diagram illustrating source codes into which a second additional statement is inserted according to an embodiment.

FIG. 9 is a schematic view illustrating a shadow memory word in the shadow memory region determined by the second additional statement according to an embodiment.

FIG. 10 is a diagram illustrating source codes into which a third additional statement is inserted according to an embodiment.

FIG. 11 is a schematic view illustrating a program to which a plurality of versions of the address sanitizer for multiple mutations execution is applied according to an embodiment.

FIG. 12 is a block diagram illustrating a compiler according to an embodiment.

### DETAILED DESCRIPTION OF THE EMBODIMENTS

In the following detailed description, only certain embodiments have been shown and described, simply by way of illustration. As those skilled in the art would realize, the described embodiments may be modified in various different ways, all without departing from the spirit or scope of the description. Accordingly, the drawings and description are to be regarded as illustrative in nature and not restrictive, and like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

In this specification, expressions described in the singular may be construed in the singular or plural unless an explicit expression such as “one” or “single” is used.

As used herein, “and/or” includes each and every combination of one or more of the recited elements.

In the specification, it will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present description.

In a flowchart described with reference to drawings in this specification, the order of operations may be changed, several operations may be merged, some operations may be divided, and specific operations may not be performed.

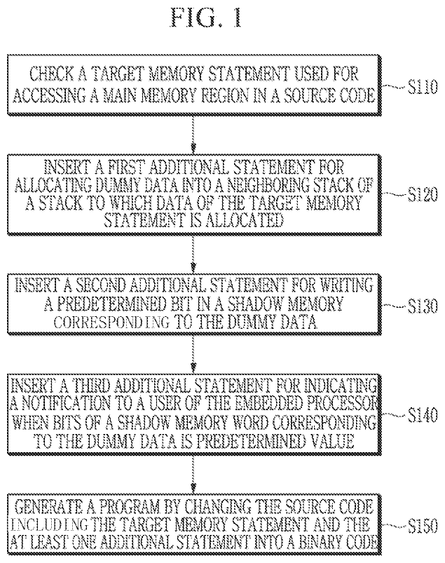

FIG. 1 is a flowchart illustrating a method for compiling source codes of a program of an embedded processor by a compiler according to an embodiment.

When a compiler according to an embodiment compiles source codes of a program of an embedded processor, a memory vulnerability detection function may be loaded in the program. For example, the compiler may apply the address sanitizer function to the program as the memory vulnerability detection function when compiling the source codes. By checking target memory statements, the compiler may insert at least one additional statement into the source codes to determine whether access for a main memory region of the target memory statements is appropriate.

Referring to FIG. 1, a compiler according to an embodiment may check at least one target memory statement accessing the main memory region from among statements included in the source codes of the program of the embedded processor S110. The compiler may check, through code analysis, which memory region the statements in the source codes accesses. In this description, among statements accessing the memory region (hereinafter referred to as ‘memory statements’), a memory statement accessing the main memory region is referred to as the target memory statement.

The data flow analysis by the compiler may be performed to check the memory region accessed by the statements. In general, because memory statements can access a peripheral region using a constant address provided by the hardware abstraction layer (HAL), the target memory statement may be easily distinguished within the source codes of the program to be run on the embedded processor.

The address sanitizer is a compiler technology to detect the memory vulnerabilities that may occur in programs written in the C language or the C++ language. When the source codes written in the C language or the C++ language is compiled, the compiler may generate the program to which the address sanitizer function is applied. The memory vulnerabilities that can be detected by the address sanitizer may include Use After Free, Heap Buffer Overflow, Stack Buffer Overflow, Global Buffer Overflow, Use After Return, Use After Scope, Initialization Order Bugs, and Memory Leaks.

If the memory vulnerability occurs during the execution of the program to which the address sanitizer is applied, the program may be terminated with a message notifying the detection of the memory vulnerability. The address sanitizer may detect the memory vulnerabilities by using a shadow memory that contains state information of the memory region being used. For example, in Intel x64 bit architecture, the address sanitizer may use the shadow memory containing 1 byte of the state information for every 8 bytes of the memory being used. A shadow memory address of the shadow memory may be determined as in Equation 1 below based on a memory address of the memory.

Shadow_memory_address=(memory_address>>3)+Offset (Equation 1)

The shadow memory may be updated when the state of memory changes according to program execution, such as the memory allocation and the release of allocated memory. When the program executes memory access statements, the address sanitizer may determine whether the access to a target memory region is valid by using the shadow memory corresponding to the target memory region. For example, when a state of a specific memory region is changed to memory-released, a value of the shadow memory corresponding to the specific memory region may be changed to indicate the release state of the memory. Then, when a memory access statement that accesses the released specific memory region is executed, the address sanitizer may determine the occurrence of the Use-After-Free vulnerability based on that the value of the corresponding area in the shadow memory corresponding to the specific memory region indicates the release state. Therefore, the address sanitizer that can detect the memory vulnerabilities may be used to develop a fuzzer that detects the memory vulnerabilities in the software verification stage.

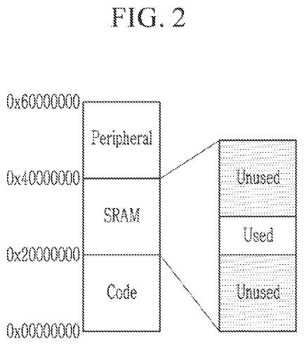

FIG. 2 is a schematic view illustrating an address space of a memory for an embedded processor according to an embodiment.

In general, an embedded processor does not include a memory management unit (MMU), so the embedded processor does not support virtual memory. The location of the main memory region used for operation in the memory (e.g., the system memory the embedded processor or the memory connected to the embedded processor) of the embedded processor may be predetermined. In addition, addresses of various peripheral devices may be also predetermined in the entire address space.

Referring to FIG. 2, address areas of SRAM (static random access memory), where main data is stored, and address areas of the peripheral devices are located separately in the address space of the memory of the embedded processor. In general, the embedded processor uses a small size of SRAM and a large portion of the SRAM may not be used during runtime since it is connected to a small number of peripheral devices.

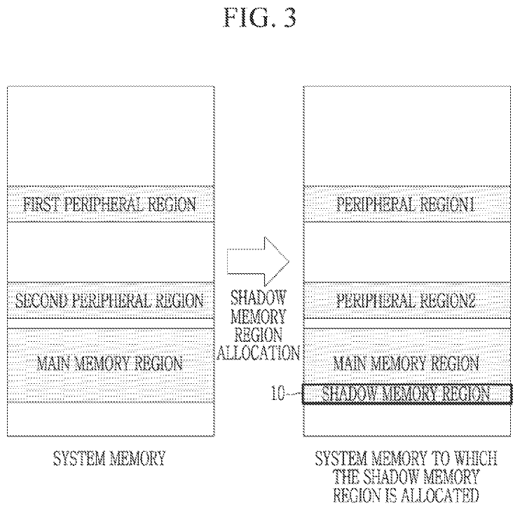

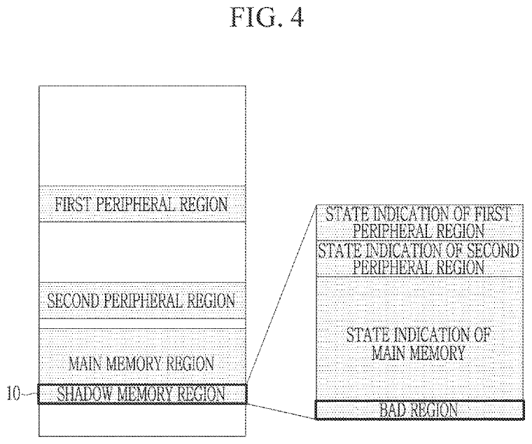

FIG. 3 is a schematic view illustrating a shadow memory allocated in a memory according to an embodiment and FIG. 4 is a schematic view illustrating a structure of a shadow memory region according to an embodiment.

Referring to FIG. 3, a shadow memory region 10 may be allocated into the main memory region of the memory of the embedded processor. The shadow memory region 10 may be used to check the state of the memory region accessed by the memory statements in the program.

Referring to FIG. 4, the shadow memory region 10 may include portions corresponding to each region of the memory. Each portion included in the shadow memory region 10 may be used to detect the occurrence of the memory vulnerability error of the embedded processor during the runtime of the program. The shadow memory region 10 may include a portion corresponding to the main memory region.

In the memory in FIG. 3, two peripheral device regions (first peripheral device region and second peripheral device region) are allocated (i.e., two peripheral devices are connected to the embedded processor), so the shadow memory region 10 may include portions corresponding to each peripheral device region (state indication of the first peripheral region and state information of the second peripheral region). Also, the shadow memory region 10 may include a portion corresponding to the shadow memory region. In FIG. 4, the portion corresponding to the shadow memory region may be a bad region. Information for preventing the bad region from being accessed by instructions may be previously stored in the bad region.

In the embedded processor according to an embodiment, a memory may be accessed as a unit of one word and because the one word occupies 4 bytes in the embedded processor, the memory of the embedded processor may be accessed as a unit of 4 bytes. Since the shadow memory can be allocated as per an access, 1 bit of the shadow memory may be allocated for every word of the memory of the embedded processor. For example, the access to the 0^{th} word in the main memory region may be controlled by checking a state value stored in the 0^{th} bit in the shadow memory region.

Equation 2 below is a part of the source codes according to an embodiment.

$$Func a \{ \\ int a [ 4 ] ; // 4 bytes * 4 = 16 bytes \\ int b [ 2 ] ; // 4 bytes * 2 = 8 bytes \qquad ( Equation 2 )$$

Referring to Equation 2, 16 bytes of memory may be allocated in the main memory region for an integer variable ‘a’ having an array length 4 and 8 bytes of memory may be allocated in the main memory region for an integer variable ‘b’ having an array length 2. Then, the shadow memory corresponding to the main memory region to which the variables are allocated may be allocated as 1 bit for each word (4 bytes). Because the variable declaration statement of equation 2 accesses the main memory region, the compiler according to the embodiment may determine the variable declaration statement of equation 2 as the target memory statement.

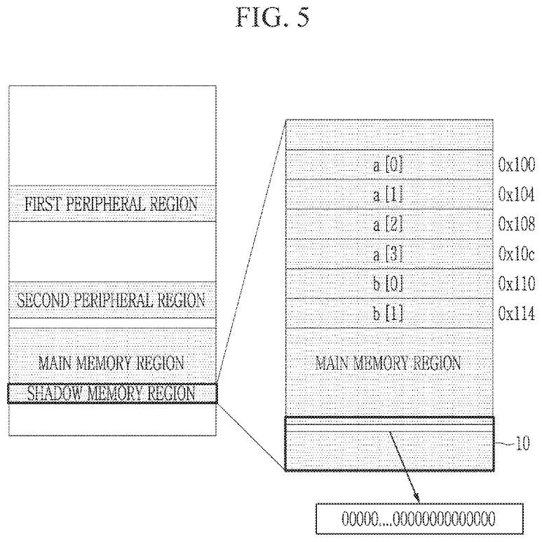

The compiler according to the embodiment may implement the memory vulnerability detection function for the embedded processor by inserting at least one additional statement into the target memory statements. Below, referring to FIG. 5 to FIG. 10, the at least one additional statement is described in detail.

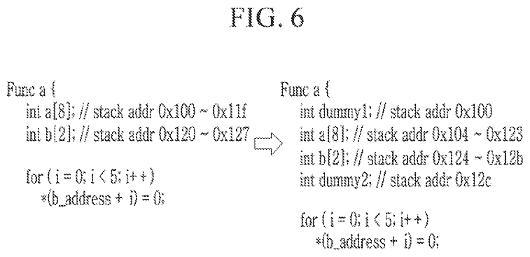

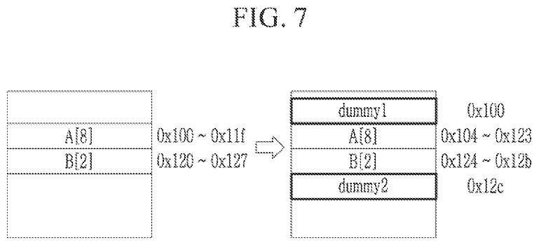

FIG. 5 is a schematic view illustrating stacks and the shadow memory of the main memory region according to an embodiment, FIG. 6 is a diagram illustrating source codes before and after insertion of additional statements according to an embodiment, and FIG. 7 is a schematic view illustrating the stacks of the main memory region changed by the additional statements according to an embodiment.

Referring to FIG. 5, the data of variables ‘a[4]’ and ‘b[2]’ declared in the source codes may be stored in a stack in the main memory region. Although it may be different according to calling convention, for the variable ‘a’ and variable ‘b’, stacks from 0x100 to 0x114 in the main memory region may be allocated. Specifically, a stack from 0x100 to 0x103 may be allocated for variable a[0], a stack from 0x104 to 0x107 may be allocated for variable a[1], a stack from 0x108 to 0x10b may be allocated for variable a[2], and a stack from 0x10c to 0x10f may be allocated for variable a[3]. In addition, a stack from 0x110 to 0x113 may be allocated for variable b[0] and a stack from 0x114 to 0x117 may be allocated for variable b[1].

Each stack in the main memory region may have corresponding bits in the shadow memory region 10. Referring to FIG. 5, a[0] may correspond to the 0^{th} bit in the shadow memory region 10, a[1] may correspond to the 1^{st} bit in the shadow memory region 10, a[2] may correspond to the 2^{nd} bit in the shadow memory region 10, and a[3] may correspond to the 3^{rd} bit in the shadow memory region 10. b[0] may correspond to the 4^{th} bit in the shadow memory region 10 and b[1] may correspond to the 5^{th} bit in the shadow memory region 10.

Referring to FIG. 1, the compiler according to the embodiment may insert a first additional statement for allocating dummy data into a neighboring stack adjacent to a stack in which data for the target memory statement is allocated S120. Referring to FIG. 6, the compiler may insert the first additional statement allocating the dummy data into before and behind the stack in which the data of a variable declaration that declares an integer variable ‘a’ with the array length 8 and a variable declaration that declares an integer variable ‘b’ with the array length 2 is to be stored. That is, the compiler may insert “int dummy1;” into the source codes so that the dummy data is stored at stack address 0x100 and insert “int dummy2;” into the source codes so that the dummy data is stored at stack address 0x12c.

Referring to FIG. 7, the stack address of the variable ‘a’ may be changed from ‘0x100 to 0x11f’ to ‘0x104 to 0x123’ and the stack address of variable ‘b’ may be changed from ‘0x120 to 0x127’ to ‘0x124 to 0x12b’ as the dummy data is allocated before and behind the stack in 4-byte units.

The compiler according to the embodiment can prevent a stack of a specific function from being invaded by other functions by allowing the dummy data to be stored in the neighboring stack of the stack corresponding to at least one variable used in the specific function. The for loop in FIG. 6 is an example to explain an Out of Bound error.

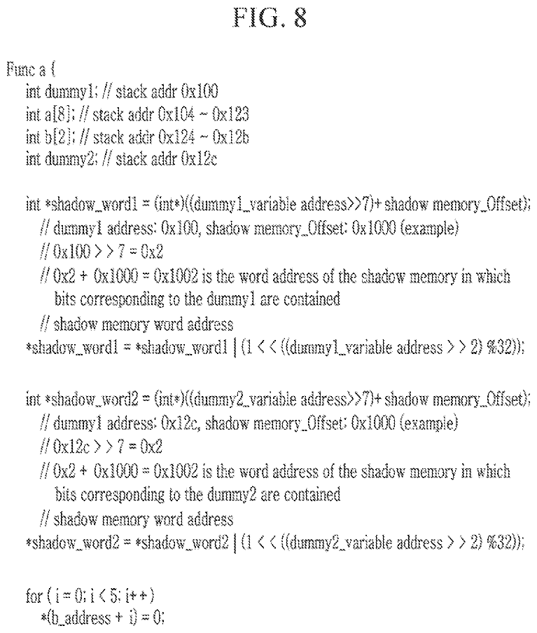

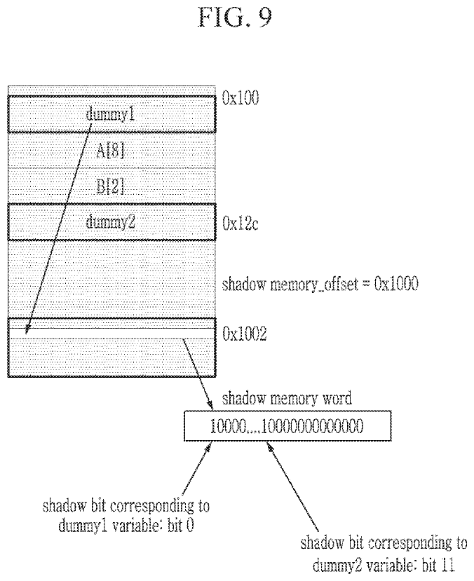

FIG. 8 is a drawing illustrating source codes into which a second additional statement is inserted according to an embodiment and FIG. 9 is a schematic view illustrating a shadow memory word in the shadow memory region determined by the second additional statement according to an embodiment.

In FIG. 1, the compiler according to an embodiment may insert a second additional statement that writes bits in the shadow memory corresponding to the dummy data into the source codes S130.

Referring to FIG. 8, the second statement for writing at least one bit in the shadow memory corresponding to the dummy data (i.e., dummy1 and dummy2) may be added to the source codes as shown in equations 3 and 4 below.

int*shadow_word=(int*)((dummy1_variable_address>>7)+shadow_memory_Offset);

*shadow_word=*shadow_word|(1<<((dummy1_variable_address>>2)%32)); (Equation 3)

int*shadow_word2=(int*)((dummy2_variable_address>>7)+shadow_memory_Offset);

*shadow_word=*shadow_word|(1<<dummy2_variable_address>>2)%32)); (Equation 4)

The first line of equations 3 and 4 (“int*shadow_word1=˜” and “int*shadow_word2=˜”) is a statement that determines the addresses of the shadow_word1 and the shadow_word2. The second line of equations 3 and 4 (“*shadow_word1=˜” and “shadow_word2=˜”) is a statement that sets the bits of the shadow_word1 and the shadow_word2 to 1.

Referring to the comments of the source codes of FIG. 8, when the shadow memory_Offset is 0x1000, the word address of the shadow memory in which the bits corresponding to the dummy1 is written is 0x1002 (the address of dummy1 is 0x100 and 0x100>>7=0x2). Referring to FIG. 9, as the bits corresponding to the dummy1, ‘1’ is written in the 0^{th} bit of the shadow memory word with address 0x1002.

Referring to the comments of the source codes of FIG. 8, when the shadow memory_Offset is 0x1000, the word address of the shadow memory in which the bits corresponding to the dummy1 is written is 0x1002 (the address of dummy1 is 0x100 and 0x12c>>7=0x2). Referring to FIG. 9, as the bit corresponding to the dummy2, ‘1’ is written in the 11^{th} bit of the shadow memory word with address 0x1002.

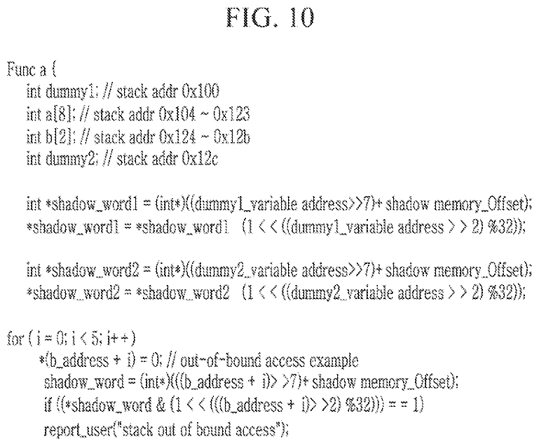

FIG. 10 is a drawing illustrating source codes into which a third additional statement is inserted according to an embodiment.

In FIG. 1, the compiler according to an embodiment may insert a third additional statement for indicating a notification to a user of the embedded processor into the source codes when bits of the shadow memory word corresponding to the dummy data is a predetermined value S140. Here, the notification may include an audiovisual warning that indicates to the user that a vulnerability error for the memory region has occurred. Referring to FIG. 10, to notify the user when the bit value written to the shadow memory word is 1,
“if ((*shadow_word&(1<<(((b_address+i)>>2)%32)))==1) report_user(“stack out of bound access”);”
   is added as the third additional statement in the source codes.

In an embodiment, the bit value of the shadow memory word that will indicate the notification to the user may be predetermined to be 1. That is, when a bit of the shadow memory is 1, it may be determined in advance that access to the data in the main memory corresponding to the bit is not allowed. Referring to FIG. 10, the memory access may be performed using “b_address”, and the access to a total of five memory words may be performed based on the b_address. Since the size of the memory word allocated to the variable ‘b’ is 2 (b[2]), the access to 5 memory words may exceed the size of the 2 words allocated to the variable ‘b’. Therefore, this can be an Out-of-Bound access that exceeds the size of the stack originally allocated for function ‘a’. Specifically, the Out-of-Bound access may be a case in which ‘I’ of the for loop is not repeated from 0 to 5, but i is repeated from 0 to a number determined by a user input (user_input). In this Out-of-Bounds access, since the bound of memory access is determined by the user's input, it may be very vulnerable code in terms of security.

Whenever the variable ‘b’ accesses the data in the memory, the third additional statement (refer to FIG. 10) may be also executed by the compiler, and accordingly, the value of the bit corresponding to the current access address, written to the stack of the shadow memory of FIG. 9 may be checked. Since 2 bits based on “B_address” are not set to 1 by the second additional statement (the code added in FIG. 8), the third additional statement (the code added in FIG. 10) may determine that the code execution of 2 bits based on “B_address” is legal access. However, when the code of “b_address+2” is executed, the region accessed by this code corresponds to the location of the dummy2. Therefore, the bit of the stack of the shadow memory shown in FIG. 9 is set to 1 by the second additional statement, and the execution of the code of “b_address+2” may be determined as the Out-of-Bound error by the third additional statement.

In general, in the case of the Out-of-Bound error or the Stack Overflow, it may be a problem that an access initiated from an accessible memory region by an incorrectly written source code crosses a boundary and leads to an inaccessible memory region. Therefore, the compiler according to the embodiment inputs a bit value into the shadow memory region for detecting whether the access to the main memory region is permitted, so that an unauthorized access may be detected whenever the access to the main memory region of the embedded processor is performed.

The compiler according to an embodiment may generate a program operating in the embedded processor by changing the source codes including the target memory statement and the at least one additional statement into a binary code S150. The compiler according to the embodiment insert at least one additional statement among the first to third additional statement described above into the source codes, so that the vulnerability detection function can be mounted on the program using the memory connected to the embedded processor or the memory of the embedded processor.

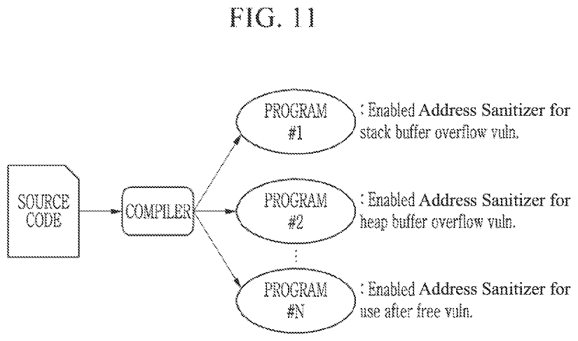

FIG. 11 is a schematic view illustrating a program to which a plurality of versions of the address sanitizer for multiple mutations execution is applied according to an embodiment.

In general, since the size of the shadow memory for the embedded processor is small, memory overhead may be large.

For example, if 1 byte of shadow memory is used for every 4 bytes in the Cortex-M processor, ¼ of the entire address area including the main memory region and peripheral area is used as the shadow memory, so the memory overhead may be large. In this case, it may be difficult to install the memory vulnerability detection module such as the address sanitizer into the program of the embedded processor.

The compiler according to an embodiment may be configured to detect one memory vulnerability for each program to be operated in the embedded processor. Referring to FIG. 11, program #1 may detect the Stack Buffer Overflow vulnerability, and may use 1 bit of shadow memory for every 4 bytes of the entire address region. For example, program #2 may detect a Heap Buffer Overflow vulnerability, and may use 1 bit of shadow memory for every 4 bytes of the entire address region. In addition, program #n may detect a Use After Free vulnerability and may use 1 bit of shadow memory for every 4 bytes of the entire address region. That is, a maximum of eight memory vulnerabilities can be detected when using the shadow memory determined to be 1 byte per 4 bytes, but the compiler according to the embodiment may consider the narrow memory space of the embedded processor and limit the size of the shadow memory to 1 to 4 bits per 4 bytes. That is, for example, during the runtime of each program, 1 to 4 memory vulnerabilities can be detected with little memory overhead through the shadow memory.

Through the additional statements inserted into the source codes, the memory vulnerability detection function can be loaded into the program using b the memory of the embedded processor or the memory connected to the embedded processor.

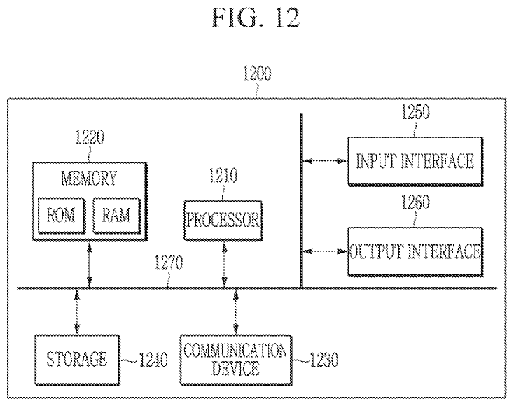

FIG. 12 is a block diagram illustrating a compiler according to an embodiment.

The compiler according to an embodiment may be implemented in a computer system, for example, a computer-readable medium. The compiler according to an embodiment may be implemented as a computer system, for example, a computer-readable medium. Referring to FIG. 12, the computer system 1200 may include at least one of a processor 1210, a memory 1220, an input interface device 1250, an output interface device 1260, and a storage device 1240 communicating through a bus 1270. The computer system 1200 may also include a communication device 1220 coupled to the network. The processor 1210 may be a central processing unit (CPU) or a semiconductor device that executes instructions stored in the memory 1230 or the storage device 1240. The memory 1230 and the storage device 1240 may include various forms of volatile or nonvolatile storage media. For example, the memory may include a read only memory (ROM) or a random-access memory (RAM).

In the embodiment of the present disclosure, the memory may be located inside or outside the processor, and the memory may be coupled to the processor through various means already known. The memory is a volatile or nonvolatile storage medium of various types, for example, the memory may include a read-only memory (ROM) or a random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 1220 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of the number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments. On the contrary, it is intended to cover various modifications and equivalent arrangements included within the spirit and scope of the appended claims.

What is claimed is:

1. A method for compiling of a source code of a program of an embedded processor, the method comprising:
determining a target memory statement to access a memory region of the embedded processor from among memory statements included in the source code;
inserting, in the vicinity of the target memory statement, an additional statement to detect a memory vulnerability error when the target memory statement accesses the memory region;
changing the target memory statement into binary codes; and
changing the additional statement into binary codes.

2. The method of claim 1, wherein
the additional statement includes a first additional statement that allocates dummy data to a neighboring stack of a stack to which data of the target memory statement is allocated.

3. The method of claim 2, wherein
the additional statement further includes a second additional statement for writing a bit in a shadow memory corresponding to the dummy data.

4. The method of claim 3, wherein
the additional statement further includes a third additional statement for displaying a notification to a user of the embedded processor when the bit written by the second additional statement in the shadow memory corresponding to the dummy data is a predetermined value.

5. The method of claim 4, wherein
the notification includes an audiovisual warning indicating that a memory vulnerability error has occurred for the memory region.

6. The method of claim 1, further comprising
generating a program to which the address sanitizer function is applied based on the binary codes of the target memory statement and the binary codes of the additional statement.

7. A compiler for compiling of a source code of a program of an embedded processor, the compiler comprising:
a processor and memory, wherein the processor executes a program stored in the memory to execute:
determining a target memory statement to access a memory region from among memory statements included in the source code;
Inserting, around the target memory statement, an additional statement to detect a memory vulnerability when the target memory statement accesses the memory region;
changing the target memory statement into binary codes; and
changing the additional statement into binary codes.

8. The compiler of claim 7, wherein
the additional statement includes a first additional statement that allocates dummy data to a neighboring stack of a stack to which data of the target memory statement is allocated.

9. The compiler of claim 8, wherein
the additional statement further includes a second additional statement that check a bit in a shadow memory corresponding to the dummy data.

10. The compiler of claim 9, wherein
the additional statement further includes a third additional statement for displaying a notification to a user of the embedded processor when the bit written by the second additional statement in the shadow memory corresponding to the dummy data is a predetermined value.

11. The compiler of claim 10, wherein
the notification includes an audiovisual warning indicating that a memory vulnerability error has occurred for the memory region.

12. The compiler of claim 7, wherein
the processor executes the program to further perform
generating a program to which the address sanitizer function is applied based on the binary codes of the target memory statement and the binary codes of the additional statement.
